(19) United States
(12) Patent Application Publication
(10) Pub. No.: US 2015/0288822 A1
(43) Pub. Date: Oct. 8, 2015

(54) Private Social Voice Messaging System

(71) Applicant: Retropreneur Labs, LLC, Neptune Beach, FL (US)

(72) Inventors: Kelly Dyer, Atlantic Beach, FL (US); Andrew Mark Ruppar, Atlantic Beach, FL (US)

(73) Assignee: RETROPRENEUR LABS, LLC, Neptune Beach, FL (US)

(21) Appl. No.: 14/677,560

(22) Filed: Apr. 2, 2015

Related U.S. Application Data
(60) Provisional application No. 61/976,310, filed on Apr. 7, 2014.

(51) Int. Cl. H04M 3/533; H04L 29/08; H04W 4/12

(52) U.S. Cl. CPC H04M 3/53333; H04W 4/12; H04L 67/30

(57) ABSTRACT

Systems, methods and computer program products for facilitating private, social voice messaging between intimate contacts, especially when the message content is meaningful, but the immediacy is not, are disclosed. In an aspect, a dedicated hardware device for the reception and playback of messages is provided along with a message creation mobile application. The application allows a remote sender to create a rich voice message on their mobile device that can be sent to a receiving party in close proximity to the dedicated reception hardware device. Once the hardware device receives the message it provides a visual and/or audio cue to the receiving party. Then, the receiving party may simply tap the device, when ready, and the rich voice message plays. Thus, the disclosed systems, methods and computer program products restore social etiquette in communications by allowing the receiving party to the time and place they receive voice communications.

### CROSS REFERENCE TO RELATED APPLICATION

This application claims the benefit of U.S. Provisional Patent Application Ser. No. 61/976,310, filed Apr. 7, 2014, and entitled “The Orb—Voice and Light Communications Network and Playback Device,” the entire contents of which are incorporated herein by reference.

### FIELD OF THE DISCLOSURE

The present disclosure generally relates to voice messaging and more particularly to systems, methods and computer program products for facilitating delivery of non-immediate, private voice messages.

### BACKGROUND

The statements in this section merely provide background information related to the present disclosure and may not constitute prior art.

In today's technological environment, with the prevalence of mobile telephones, text messaging is the most common used data application in the world—more so than email! Currently over 6 billion texts a day are sent in the United States. The popularity of SMS is not surprising given the growth of the mobile industry as a whole. In 2013, according to the International Telecommunication Union (ITU), there were 6.8 billion mobile subscribers which represent approximately 96% of the world's population. In contrast, in 2010, there were only 1.2 billion fixed telephone lines in the world.

Given today's technological environment, people are frequently interrupted by their mobile telephones vibrating, ringing, “pinging” or otherwise immediately alerting them when a text message (or even an email, instant message or social networking message) arrives. In fact, one study has shown that an average user checks their mobile telephone over 110 times per day! This has left other forms of non-immediate communication—namely voicemails—largely unused. That is, the least used feature of modern mobile telephone (i.e., “smart phones”) is the actual telephone feature! It is not uncommon for people to avoid voice calling, and even when a called is placed and a voicemail left, people rarely listen to them. In sum, voice messaging is quickly becoming a relic of the past. This is troubling not so much so with respect to the hundreds of contacts your average mobile subscriber has stored in their telephones, but for the few or tens of close (e.g., family) and intimate contacts whose voices subscribers should be and wish to be hearing.

Put another way, today's pervasive use of text (and instant) messaging has created an immediacy expectation in communications, where: there is no way to send a message which does not disturb the receiving party “now” with an alert, ring, etc.; the instantaneous and mobile people message creates an implied sense of urgency to respond (even if this was never the sender's original intent); there is more connectivity, but less actual communications; and people do not communicate with those that matter to them the most (e.g., family) with the richness of their voices.

In sum, the “mobile telephone and mobile app” age has made it increasingly convenient to send messages, but technology has not yet made it convenient to receive voice messages.

Given the foregoing, systems, methods, and computer program products are needed which facilitate private, social voice messaging between intimate contacts especially when the message content is meaningful, but the immediacy is not.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products for facilitating private, social voicemail messaging between intimate contacts especially when the message content is meaningful, but the immediacy is not.

In an aspect, a private social voice messaging system is provided that allows two-way convenience with one-way voice messaging. The disclosed system combines a dedicated hardware device for the reception and playback of messages—which may include at least voice in addition to data, video, emoticons and/or light messages—sent through a mobile application. Such system serves as a bridge connecting two parties with different schedules at the perfect time.

In an aspect, the dedicated hardware device in accordance with the present disclosure connects via wireless communications (e.g., Wi-Fi) to the global, public Internet to receive messages. Thus, the owner of the device is freed during their day to remain open to receiving voice messages without needing to hear them until they are physically in close proximity to the device. The sender is free to send their message at any time without implied urgency and without creating any disruption to the receiving party's busy day or rest period.

In an aspect, systems, methods, and computer program products in accordance with the present disclosure sets a sending party free by giving them a better way to message with those that matter most through the rich expression of their voice without any disruption to the lives of the sending/calling party's and receiving/called party.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating private, social voice messaging between intimate contacts, according to an aspect of the present disclosure.

FIG. 2 is a flowchart illustrating an exemplary process for private, social voice messaging between intimate contacts, according to an aspect of the present disclosure.

FIG. 3 is a block diagram of an exemplary computing system useful for implementing aspects of the present disclosure.

FIG. 4 is a block diagram of an exemplary diagram of a reception and playback device, according to an aspect of the present disclosure.

### DETAILED DESCRIPTION

The present disclosure is directed to systems, methods, and computer program products for facilitating private, social voice messaging between intimate contacts, especially when the message content is meaningful, but the immediacy is not.

In an aspect, a system is provided that includes a message creation mobile application and a dedicated hardware device for the reception and playback of messages. The system thus facilitates private, social voice messaging that introduces two-way convenience with one-way voice messaging for users that are closest friends and family.

In an aspect, methods and computer program products are disclosed which allow a user (“calling party”) to create and send a voice message to a contact (i.e., “receiving party”) within their social network. Such message may include voice, along with data, video, emoticons and/or light-based messages. Then, rather than intrusively ringing the receiving party's mobile telephone and/or altering their wearable mobile device wherever they are, the message is directed, via one or more communications networks, to a dedicated hardware device previously purchased and conveniently placed by the receiving party (e.g., in their home or office).

In aspects of the present disclosure, the sender may select one or more colors to be associated with their message, and the receiving party's dedicated reception and playback device glows with the selected color(s) as an indication of arrival of the new message. When the receiving party is in close proximity to the device, they can simply tap or otherwise activate it to experience the calling party's message.

In aspects of the present disclosure, the lost value of voice communication is reintroduced to a “mobile telephone and app” world. That is, the systems, methods, and computer program products of the present disclosure allows people to communicate more richly with those they care about most while using their voice. This is accomplished by providing one-way messaging convenience that has made all other messaging apps so preferable in today's society, but specifically for voice, where other apps have fallen short due to the intrusive immediacy of telephone-only delivery.

The terms “sender”, “receiver,” “party,” “customer,” “contact,” “user”, and/or the plural form of these terms are often used interchangeably throughout herein to refer to those persons or entities capable of accessing, using, being affected by and/or benefiting from the private, social voice messaging tool that the present disclosure provides.

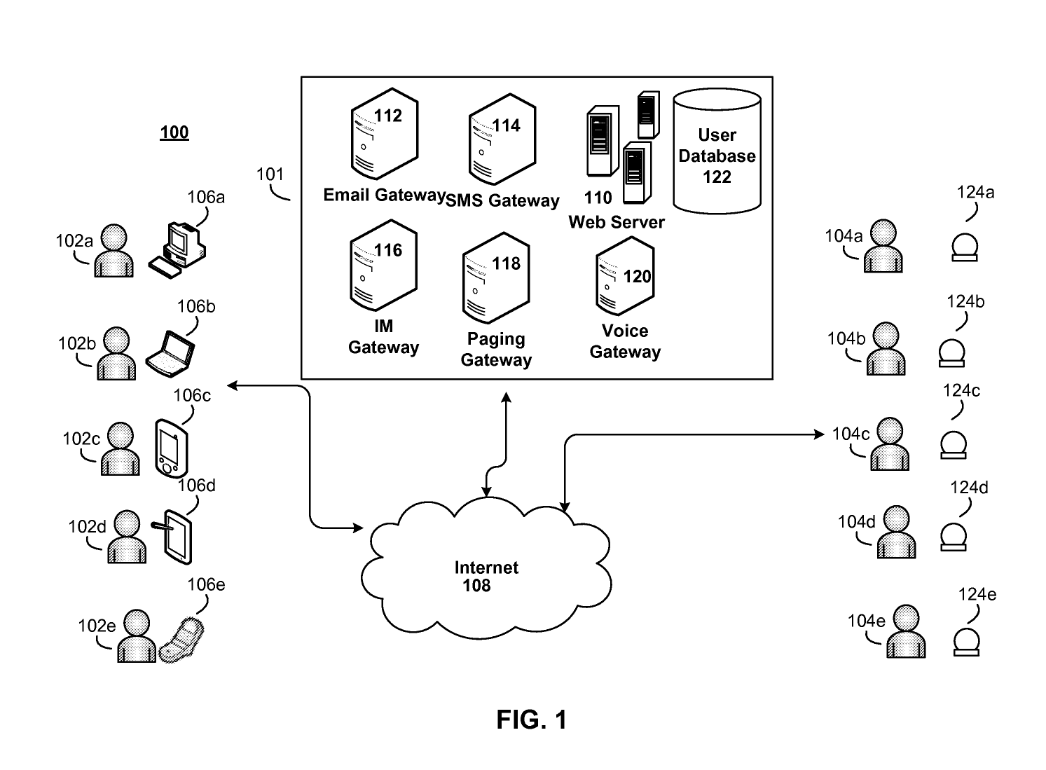

Referring now to FIG. 1, a block diagram of an exemplary system 100 for facilitating private, social voice messaging between intimate contacts, according to an aspect of the present disclosure, is shown.

Cloud-based, Internet-enabled system 100 includes a plurality of calling party or sending users 102 (shown as users 102a-e in FIG. 1) accessing—via a computing device 106 (shown as respective computing devices 106a-j in FIG. 1) and a network 108, such as the global, public Internet—an application service provider's cloud-based, Internet-enabled infrastructure 101. User 102 may access infrastructure 101 via, for example, computing device 106 in order to facilitate private, social voice messaging between themselves and their intimate contacts (i.e., message receivers 104).

In various aspects, computing device 106 may be configured as: a desktop computer 106a; a laptop computer 106b; a Personal Digital Assistant (PDA) or mobile telephone 106c; a tablet or mobile computer 106d; a cellular telephone 106e; any commercially-available intelligent communications device with voice recordation functionality; any wearable mobile device (e.g., a smartwatch); or the like.

As shown in FIG. 1, in an aspect of the present disclosure, an application service provider's cloud-based, communications infrastructure 101 may include one or more web servers 110, an email gateway 112, an SMS gateway 114, an Instant Message (IM) gateway 116, a paging gateway 118, a voice gateway 120, and a user database 122.

User database 122 may be configured to store data collected from customers 102 and 104 who subscribe to the tool of the present disclosure. Data collected from customers 102 and 104 may include customer information such as login information, preferences, demographics, contact information, contact list, social network memberships, message format preferences, message templates, devices 106 used, privacy settings, and the like.

In an aspect of the present disclosure, a message created by a user 102 on device 106 is sent via infrastructure 101 to a recipient 106 on a previously-purchased, registered and configured, dedicated reception and playback device 124. In such an aspect, device 124 is a small (i.e., night-stand placeable) electronic device with wireless communications (e.g., Bluetooth, Wi-Fi, etc.) capability such that it may communicate with infrastructure 101 via at least the global, public Internet 108 and a local area (wireless) network. Further, device 124 has audio speakers capable of playing the digital voice messages created by users 102 in a location and at a time convenient for users 104. In an alternate embodiment, device 124 also includes a display (e.g., an LED display) for displaying content rich messages comprising data, video, emoticons and/or various light color, pattern and brightness effects. As will also be appreciated by those skilled in the relevant art(s) after reading the description herein, each device 124 registered with infrastructure 101 would have a unique identifier such that web server 110 may provision the right voice message to the right addressee (i.e., device 124) to reflect the intimate contact selections of users 102. In various aspects, device 124 would be powered by a (disposable) battery, a USB charging port and/or an AC electrical wall plug. Lastly, in various aspects, device 124 also comprises an input device (e.g., button, switch, touch pad, click pad or the like) so as to allow user 104 to activate playback of any message received from users 102.

As will be appreciated by those skilled in the relevant art(s) after reading the description herein, in an aspect, an application service provider—an individual person, business, or other entity—may allow access, on a free registration, paid subscriber, freemium, and/or pay-per-use basis, to infrastructure 101 via one or more World-Wide Web (WWW) sites on the Internet 108, as well as make devices 124 available for purchase by customers 102 and 104. Thus, system 100 is scalable.

As will also be appreciated by those skilled in the relevant art(s), in an aspect, various (registration, login, payment, account, address book, and message creation, deletion and review, etc.) screens would be generated by server 110 in response to input from customers 102 over Internet 108. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 106 being used by various customers 102. Thus, server 110 is able to provide a graphical user interface (GUI) to customers 102 of system 100 in the form of webpages. These webpages are sent to the user's PC, laptop, mobile device, PDA or like device 106, and would result in the GUI being displayed.

As will be appreciated by those skilled in the relevant art(s) after reading the description herein, alternate aspects of the present disclosure may include providing a tool for facilitating private, social voice messaging between intimate contacts to devices 106 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where senders 102 and receivers 104 are all personnel/employees of the same entity, the present disclosure may be implemented as a stand-alone system, rather than as a cloud-based/web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating private, social voice messaging between customers 102 and receivers 104 from infrastructure 101 to devices 106 via a special purpose app, a browser pre-installed with an applet, or a browser with a separately downloaded applet on such devices 106. That is, as will also be apparent to one skilled in the relevant art(s) after reading the description herein, the app that facilitates the intimate contact tool disclosed herein, may be part of the “standard” browser that ships with computing device 106 or may be later added to an existing device 106 functionality (via its browser or as a native application executing thereon) as part of an “add-on,” “plug-in,” or “app store download.”

As will also be appreciated by those skilled in the relevant art(s) after reading the description herein, the web, cloud-based service implemented by system 100 may be utilized by grandchildren (102) messaging their grandparents (104), a parent (102) away on business sending a message to their kids (104) when they are awake, spouses (102 and 104) with different schedules sharing a quick thought, long-distant relationship participants (102 and 104) or globally-separated families (102 and 104).

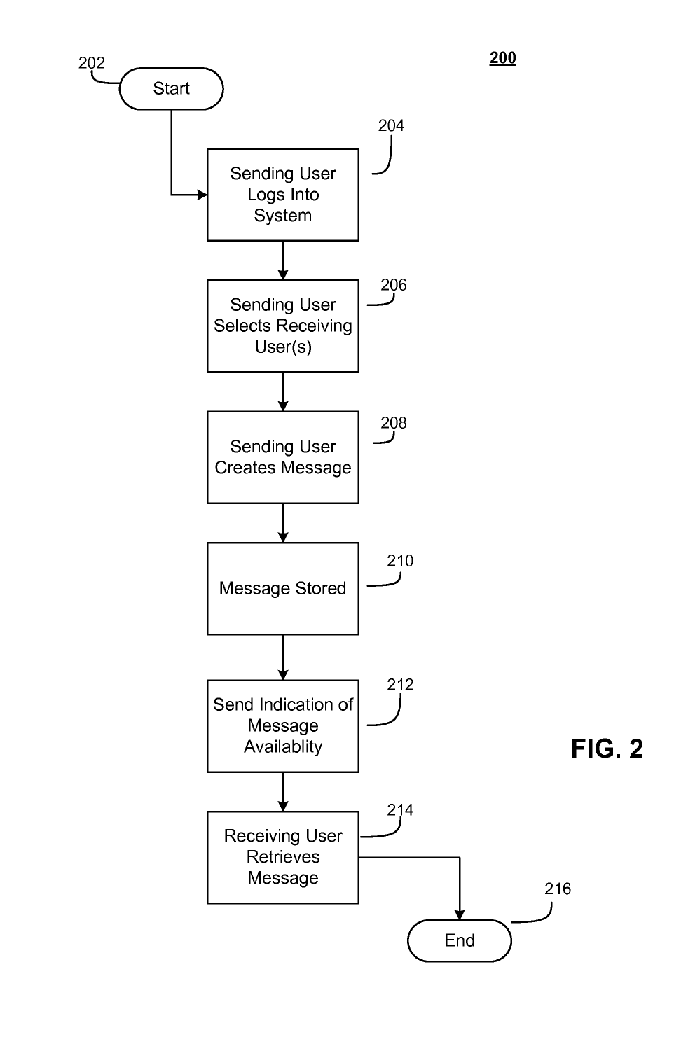

Referring now to FIG. 2, a flowchart illustrating an exemplary process 200 for facilitating private, social voice messaging between subscriber 102 and one or more of their intimate contacts 104, according to an aspect of the present disclosure, is shown.

Process 200, which may execute within system 100, begins at step 202 with control passing immediately to step 204.

In step 204, user 102 accesses (i.e., “logs into”) infrastructure 101 in order to be able to create and send rich voice messages to their intimate contacts. In various embodiments, user 102 may accesses infrastructure 101 either via a special purpose app executing on device 106 or by utilizing a browser to access a web page served by web server 120, as will be appreciated by those skilled in the relevant art(s). As used herein, accessing infrastructure 101 would encompass creating an account, verifying contact (i.e., email) information, entering or uploading contacts, setting preferences and perhaps registering payment information, all as will be appreciated by those skilled in the relevant art(s).

In step 206, user 102 selects one or more intimate contacts (i.e., one or more receiver users 104) to which they would like to send a rich voice message. As will be appreciated by those skilled in the relevant art(s), each contact 104 selected is presumed to be in the possession of a previously-purchased and configured, dedicated reception and playback device 124. Thus, database 122 would only include contacts for those users 104 who previously-purchased, configured and registered device 124 with infrastructure 101; allowing the special purpose app executing on device 106 or the web page served by web server 120 to verify the selection of one or more contacts in step 206. Similarly, users 104 may access web server 110 via browser or mobile app to specify preferences as to which users 102 from which they desire to receive messages.

In step 208, user 104 creates a private voice message for one or more users 104 utilizing the voice recordation functionality of their device 106 (i.e., microphone of a smartphone, laptop, desktop, PDA or the like device 106) in response to prompts from the special purpose app or web page served by web server 110. In alternate embodiments, the special purpose app or web page not only facilitates user 104 recoding a private voice message, but may also allow user 102 to select one or more associated data or rich content (e.g., a multimedia message of light with color, pattern and brightness effect selections so that when called party 104 listens to the voice message they may also viewing the associated data).

In step 210, the message created by user 102 is stored within infrastructure 101 for later downloading by, or streaming to, one or more devices 124.

In step 212, infrastructure 101 delivers a “message available” indication to device 124 associated with the one or more users 104 selected by user 102 in step 206. In alternative embodiment, the “message available” indication may be any audio and/or visual cue utilizing the devices speakers and/or display so that user 104—when in proximity to device 124—is alerted that a message is available for playback.

In step 214, when user 104 is in close proximity to device 124 and desires to retrieve the message created by user 102, user 104 may depress a button on device 124 to activate device 124 in order to playback the private audio message (as well as display any rich content created by user 102 in step 208). As will be appreciated by those skilled in the relevant art(s), in various aspects, infrastructure 101 may provision (i.e., deliver) the message content to device 124: (a) in an “on demand” manner, prior to actual user 104 activating playback (wherein the content is stored locally on device 124 prior to actual playback); or (b) in a buffered, streaming or hybrid manner depending on available memory on device 124 and/or the local network bandwidth on which device 124 receives communications from infrastructure 101.

As will be appreciated by those skilled in the relevant art(s) after reading the description herein, process 200 facilitates private, social voice messaging between intimate contacts especially when the message content is meaningful, but the immediacy is not. That is, message receiver 104 may hear the voice of message creator 102 saying, “I miss you,” along with a flickering glow of their favorite color as selected by user 102 during message creation step 208. The message can brighten someone's day with an uplifting message. The illumination controls and light patterns displayed by device 124 is a way to substitute voice when appropriate or to create a physical experience along with the voice message. Through conventional remote communications, users cannot reach-out in a tactile or physical way. Through the control of the lights on device 124, however, sending user 102 has a portal to the environment of user 104 and can make their presence “felt” by connecting through device 124.

Process 200 then concludes as indicated by step 216.

As will be appreciated by those skilled in the relevant art(s), the tool of the present invention may implemented as a new, stand-alone social network site 101 or its features may be added as part of a pre-existing existing social networking site.

As will be appreciated by those skilled in the relevant art(s), after reading the disclosure herein, in an alternate embodiment, process 200 may simply deliver the created message directly from device 106 to device 124 if the two devices are in close proximity to each other or otherwise can communicate directly (e.g., on the same Wi-Fi network or within Bluetooth or other short-distance, wireless technology standard range).

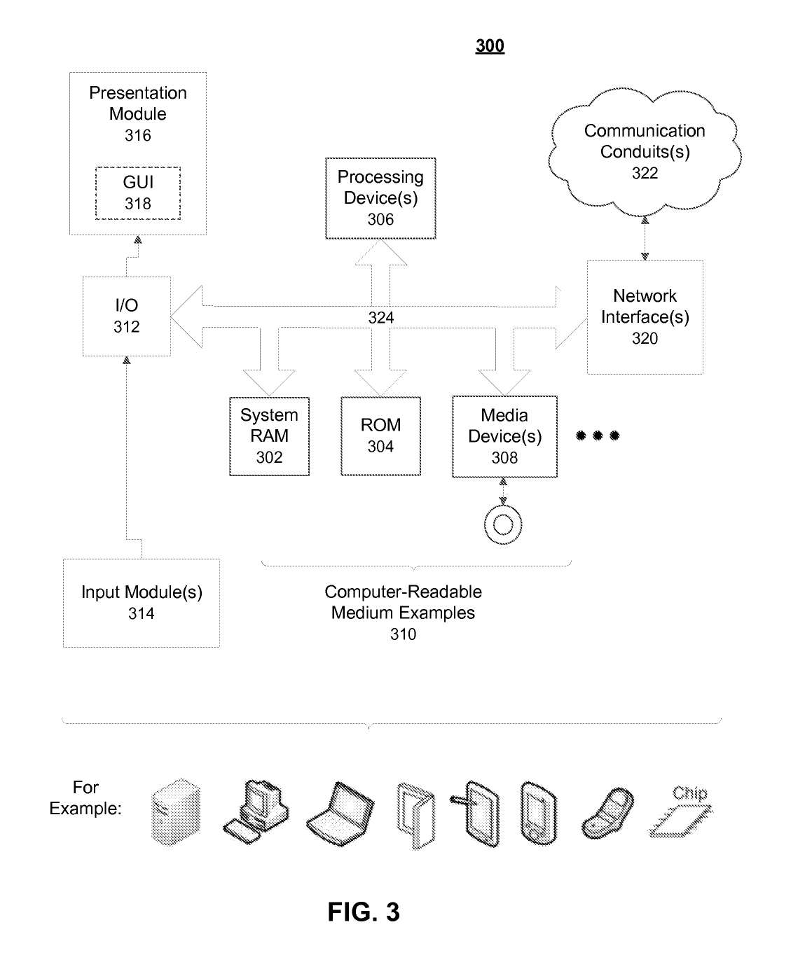

Referring now to FIG. 3, a block diagram of an exemplary computer system useful for implementing various aspects the processes disclosed herein, in accordance with one or more aspects of the present disclosure, is shown.

That is, FIG. 3 sets forth illustrative computing functionality 300 that may be used to implement web server 110, one or more gateways 112-120, user database 122, computing devices 106 and 124 utilized by customers 102 and recipients 104, respectively, or any other component of system 100. In all cases, computing functionality 300 represents one or more physical and tangible processing mechanisms.

Computing functionality 300 may comprise volatile and non-volatile memory, such as RAM 302 and ROM 304, as well as one or more processing devices 306 (e.g., one or more central processing units (CPUs), one or more graphical processing units (GPUs), and the like). Computing functionality 300 also optionally comprises various media devices 308, such as a hard disk module, an optical disk module, and so forth. Computing functionality 300 may perform various operations identified above when the processing device(s) 306 execute(s) instructions that are maintained by memory (e.g., RAM 302, ROM 304, and the like).

More generally, instructions and other information may be stored on any computer readable medium 310, including, but not limited to, static memory storage devices, magnetic storage devices, and optical storage devices. The term “computer readable medium” also encompasses plural storage devices. In all cases, computer readable medium 310 represents some form of physical and tangible entity. By way of example, and not limitation, computer readable medium 310 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 302, ROM 304, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 300 may also comprise an input/output module 312 for receiving various inputs (via input modules 314), and for providing various outputs (via one or more output modules). One particular output module mechanism may be a presentation module 316 and an associated GUI 318. Computing functionality 600 may also include one or more network interfaces 320 for exchanging data with other devices via one or more communication conduits 322. In some embodiments, one or more communication buses 324 communicatively couple the above-described components together.

Communication conduit(s) 322 may be implemented in any manner (e.g., by a local area network, a wide area network (e.g., the Internet), and the like, or any combination thereof). Communication conduit(s) 322 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

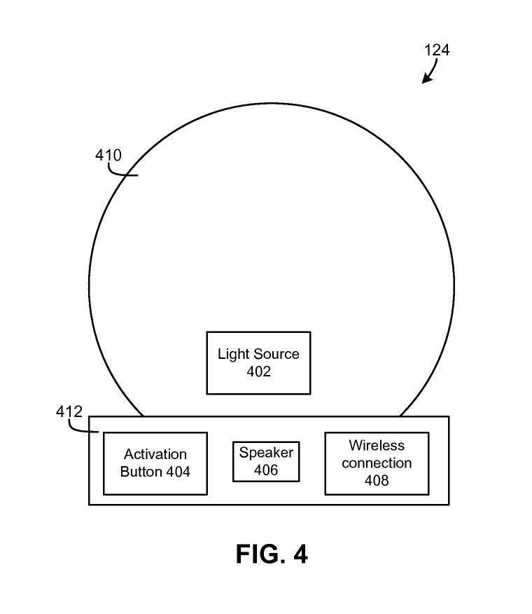

Referring now to FIG. 4, a block diagram of reception and playback device 124, according to various aspects of the present disclosure, is shown.

Device 124 may include a base 412 and a depressible decorative housing 410. Housing 402 may have an aesthetically pleasing shape, contain a light source 402 and be constructed of translucent material which diffuses light from light source 402 when light source 402 is activated, causing housing 410 to glow. Light source 402 may be activated to indicate the presence of a rich voice message from user 102 of infrastructure 101.

An activation button 404 may be coupled to housing 410 and triggered when housing 410 is tapped and pressed. In other aspects, activation button 404 may be separated from housing 410, motion activated, or activated in another manner apparent to those skilled in the relevant art(s) after reading the description herein.

Device 124 also contains a speaker 406 to playback messages and at least one wireless connection 408.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

What is claimed is:

1. A computer-implemented method of delivering private, social network voice messages to intimate contacts, comprising the steps of:
(a) receiving, via at least one network, a rich voice message from a first user utilizing a computing device;
(b) receiving, from said first user utilizing said computing device, via said at least one network, a selection of a second user for whom said rich voice message is intended;
(c) storing, in a database, said rich voice message received from said first user;
(d) sending a first indication, via said at least one network, to a dedicated playback device associated with said second user that said rich voice message is available;
(e) receiving, via said at least one network, a second indication that said second user is in close proximity to said dedicated playback device and desires to listen to said rich voice message;
(f) retrieving, from said database, said rich voice message; and
(g) delivering, via said at least one network, said rich voice message to said dedicated playback device;
whereby said delivering step (g) facilitates non-intrusive, time-shifted communications between said first user and said second user when the contents of said rich voice message is important but its immediacy is not.

2. The computer-implemented method of claim 1, wherein said at least one network is the global, public Internet.

3. The computer-implemented method of claim 2, wherein said rich voice message is delivered to said dedicated playback device via said global, public Internet and a wireless network.

4. The computer-implemented method of claim 3, wherein said wireless network is one of: a Bluetooth connection; and a Wi-Fi network.

5. The computer-implemented method of claim 1, wherein said rich voice message delivered, via said at least one network, to said dedicated playback device comprises:
(a) voice data; and
(b) at least one of: video; an emoticon; a light color; a light pattern; and a light brightness indicator.

6. One or more computer storage media having stored thereon multiple instructions that facilitate delivering a private, social network voice message to an intimate contact by, when executed by one or more processors of a computing device, causing the one or more processors to:
(a) receive, via at least one network, a rich voice message from a first user utilizing a computing device;
(b) receive, from said first user utilizing said computing device, via said at least one network, a selection of a second user for whom said rich voice message is intended;
(c) store, in a database, said rich voice message received from said first user;
(d) send a first indication, via said at least one network, to a dedicated playback device associated with said second user that said rich voice message is available;
(e) receive, via said at least one network, a second indication that said second user is in close proximity to said dedicated playback device and desires to listen to said rich voice message;
(f) retrieve, from said database, said rich voice message; and
(g) deliver, via said at least one network, said rich voice message to said dedicated playback device.

7. One or more computer storage media as recited in claim 6, wherein said at least one network is the global, public Internet.

8. One or more computer storage media as recited in claim 7, wherein said rich voice message is delivered to said dedicated playback device via said global, public Internet and a wireless network.

9. One or more computer storage media as recited in claim 7, wherein said wireless network is one of: a Bluetooth connection; and a Wi-Fi network.

10. One or more computer storage media as recited in claim 6, wherein said rich voice message delivered, via said at least one network, to said dedicated playback device comprises:
(a) voice data; and
(b) at least one of: video; an emoticon; a light color; a light pattern; and a light brightness indicator.

11. A system for delivering private, social network voice messages to intimate contacts, the system comprising:
(a) at least one web server capable of providing a graphical user interface, via a communications network, to a first user computing device and a second user dedicated playback device;
(b) a database, communicatively coupled to said at least one web server via said communications network; and
(c) an application module executing on said at least one web server, comprising:
(i) means for receiving, via said communications network, a rich voice message from a first user utilizing a computing device;
(ii) receiving, from said first user utilizing said computing device, via said at least one network, a selection of a second user for whom said rich voice message is intended;
(iii) means for storing, in said database, said rich voice message received from said first user;
(iv) means for sending a first indication, via said communications network, to a dedicated playback device associated with said second user that said rich voice message is available;
(v) means for receiving, via said communications network, a second indication that said second user is in close proximity to said dedicated playback device and desires to listen to said rich voice message;
(vi) means for retrieving, from said database, said rich voice message; and
(vii) means for delivering, via at least said communications network, said rich voice message to said dedicated playback device;

12. The system of claim 11, wherein said communications network is the global, public Internet.

13. The system of claim 12, wherein said rich voice message is delivered to said dedicated playback device via said global, public Internet and a wireless network.

14. The system of claim 13, wherein said wireless network is one of: a Bluetooth connection; and a Wi-Fi network.

15. The system of claim 11, wherein said rich voice message delivered, via said communications network, to said dedicated playback device comprises:
(a) voice data; and
(b) at least one of: video; an emoticon; a light color; a light pattern; and a light brightness indicator.

16. A dedicated device for receiving private, social network voice messages from intimate contacts, comprising:
(a) a wireless network component capable of communicating, via at least one communications network, to a web server to receive at least one rich voice message, wherein said least one rich voice message comprises:
(i) voice data; and
(ii) at least one of: video; an emoticon; a light color; a light pattern; and a light brightness indicator;
(b) an input device capable of receiving an indication from said user that they would like to experience said at least one rich voice message;
(c) an audio speaker capable playing said voice data included in said rich voice message to a user; and
(d) a output device capable of presenting to said user said at least one of: video; an emoticon; a light color; a light pattern; and a light brightness indicator.

17. The device of claim 16, further comprising:
(e) a memory capable of storing said at least one rich voice message received from said web server via said at least one communications network;

18. The device of claim 17, further comprising:
(f) means for notifying said user that said at least one rich voice message received from said web server is stored in said memory.

19. The device of claim 16, wherein said at least one communications network is the global, public Internet.

20. The device of claim 19, further comprising:
(e) a unique identifier capable of being used by said web server when sending said at least one rich voice message to address where said at least one rich voice message is delivered via said global, public Internet.
